(19) United States
(12) Patent Application Publication
(10) Pub. No.: US 2025/0023132 A1
(43) Pub. Date: Jan. 16, 2025

(54) ENERGY STORAGE DEVICE

(71) Applicant: TOYOTA JIDOSHA KABUSHIKI KAISHA, Toyota-shi (JP)

(72) Inventors: Keisuke Ukita, Toyota-shi (JP); Yusuke Kuruma, Toyota-shi (JP); Tsubasa Migita, Sakai-shi (JP); Kei Morikawa, Toyota-shi (JP); Yasumasa Oguma, Nagoya-shi (JP)

(73) Assignee: TOYOTA JIDOSHA KABUSHIKI KAISHA, Toyota-shi (JP)

(21) Appl. No.: 18/751,552

(22) Filed: Jun. 24, 2024

(30) Foreign Application Priority Data
Jul. 14, 2023 (JP) 2023-115848

(51) Int. Cl. H01M 10/52; H01M 50/209; H01M 50/271; H01M 50/30; H01M 50/358

(52) U.S. Cl. CPC H01M 10/52; H01M 50/209; H01M 50/271; H01M 50/358; H01M 50/394

(57) ABSTRACT

An energy storage device includes a plurality of energy storage cells, a case, and a desulfurization unit. The case includes a top wall, and the top wall includes a discharge portion that discharges gas from inside the case to outside the case. The desulfurization unit includes a desulfurization agent and a communication path that contains the desulfurization agent and that allows the inside of the case to communicate with the discharge portion. The communication path includes a discharge-side vertical path extending downward from the discharge portion, a support path extending horizontally from a lower end of the discharge-side vertical path and supporting the desulfurization agent, and a suction-side vertical path extending upward from an end of the support path and opening into the case.

### CROSS-REFERENCE TO RELATED APPLICATION

This application claims priority to Japanese Patent Application No. 2023-115848 filed on Jul. 14, 2023, incorporated herein by reference in its entirety.

### BACKGROUND

### 1. Technical Field

The present disclosure relates to energy storage devices.

### 2. Description of Related Art

For example, Japanese Unexamined Patent Application Publication No. 2021-197221 (JP 2021-197221 A) discloses an all-solid-state battery pack including a plurality of all-solid-state cells, a housing that houses the all-solid-state cells, a gas intake mechanism that introduces gas from outside the housing into the housing, and a discharge mechanism that discharges gas from inside the housing to outside the housing.

### SUMMARY

In the all-solid-state battery pack described in JP 2021-197221 A, a desulfurization agent is sometimes used to remove hydrogen sulfide contained in the gas in the casing. In this case, if the desulfurization agent is crushed due to vibration etc., a discharge portion may be blocked.

An object of the present disclosure is to provide an energy storage device that can reduce blockage of a discharge portion.

An energy storage device according to an aspect of the present disclosure includes:
a plurality of energy storage cells;
a case that houses the energy storage cells; and
a desulfurization unit disposed in the case.
   The case includes a top wall disposed above the energy storage cells.
   The top wall includes a discharge portion that discharges gas from inside the case to outside the case.
   The desulfurization unit includes
a desulfurization agent, and
a communication path that contains the desulfurization agent and that allows inside of the case to communicate with the discharge portion.
   The communication path includes: a discharge-side vertical path extending downward from the discharge portion; a support path extending horizontally from a lower end of the discharge-side vertical path and supporting the desulfurization agent; and a suction-side vertical path extending upward from an end of the support path and opening into the case.

The present disclosure can provide an energy storage device that can reduce blockage of a discharge portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating an energy storage device according to an embodiment of the present disclosure;

FIG. 2 is a plan view schematically showing a desulfurization unit; and

FIG. 3 is a cross-sectional view taken along III-III line in FIG. 2.

### DETAILED DESCRIPTION OF EMBODIMENTS

Embodiments of the present disclosure will be described with reference to the drawings. In the drawings referred to below, the same or corresponding members are denoted by the same reference numerals.

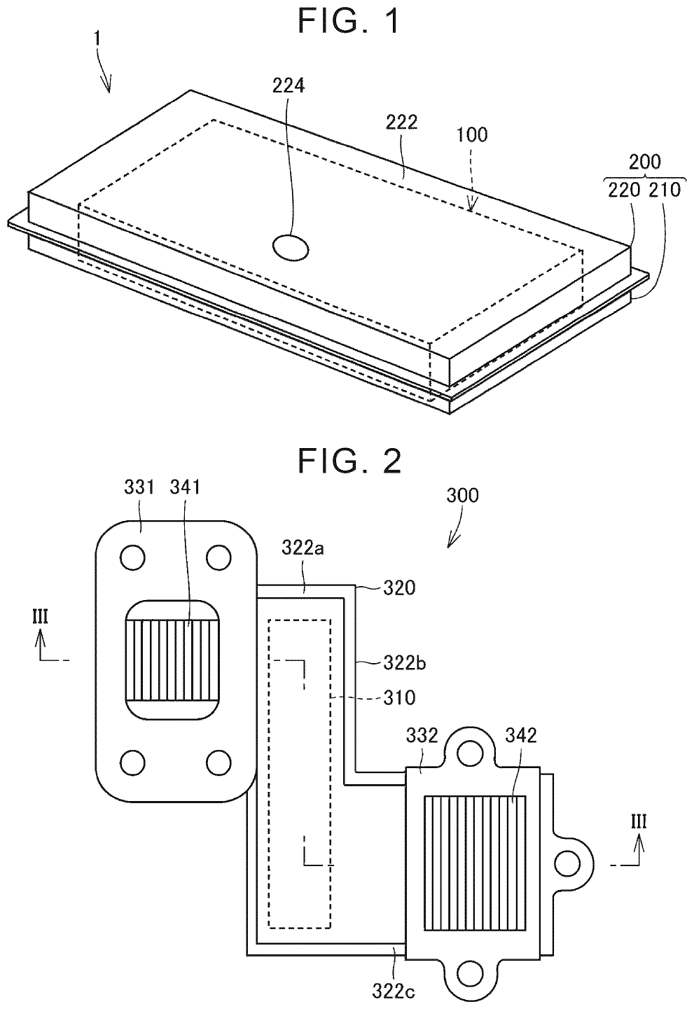

FIG. 1 is a perspective view schematically illustrating an energy storage device according to an embodiment of the present disclosure. The energy storage device 1 is preferably mounted on a vehicle.

As illustrated in FIG. 1, the energy storage device 1 includes a plurality of energy storage cells 100, a case 200, and a desulfurization unit 300.

The plurality of energy storage cells 100 are arranged in one direction (for example, the width direction of the vehicle). Examples of the energy storage cells 100 include lithium-ion batteries. Each energy storage cell 100 is formed in a flat rectangular parallelepiped.

The case 200 houses a plurality of energy storage cells 100. The case 200 includes a lower case 210 that opens upward, and an upper cover 220 that houses the plurality of energy storage cells 100 together with the lower case 210. The upper cover 220 includes a top wall 222 disposed above the plurality of energy storage cells 100. The top wall 222 has a discharge portion 224 for discharging the gas (including hydrogen sulfide gas) in the case 200 to the outside of the case 200. The discharge portion 224 is constituted by a pressure regulating valve (so-called respiratory membrane).

The desulfurization unit 300 removes sulfur-based components from the gas in the case 200. The desulfurization unit 300 includes a desulfurization agent 310, a communication path 320, a discharge-side holding plate 331, a suction-side holding plate 332, a discharge-side filter 341, and a suction-side filter 342.

The desulfurization agent 310 is formed in a pellet shape.

The communication path 320 contains the desulfurization agent 310, and allows the inside of the case 200 to communicate with the discharge portion 224. The communication path 320 includes a discharge-side vertical path 321, a support path 322, and a suction-side vertical path 323.

The discharge-side vertical path 321 extends downward from the discharge portion 224.

The support path 322 extends horizontally from a lower end of the discharge-side vertical path 321. The support path 322 supports the desulfurization agent 310.

The suction-side vertical path 323 extends upward from an end of the support path 322. An upper end of the suction-side vertical path 323 opens into the case 200. An upper end of the suction-side vertical path 323 is spaced downward from the top wall 222.

As shown in FIG. 2, the support path 322 has a first path 322a, a second path 322b, and a third path 322c.

The first path 322a extends from the lower end of the discharge-side vertical path 321 in a first direction (the left-right direction in FIG. 2) perpendicular to the vertical direction. In the present embodiment, the first path 322a extends in a direction approaching the suction-side vertical path 323 in the first direction.

The second path 322b extends from the lower end of the suction-side vertical path 323 in the first direction. In the present embodiment, the second path 322b extends in a direction approaching the discharge-side vertical path 321 in the first direction.

The third path 322c connects the first path 322a and the second path 322b. The third path 322c is shaped to extend along a second direction (the up-down direction in FIG. 2) perpendicular to both the vertical direction and the first direction. The desulfurization agent 310 is disposed in the third path 322c.

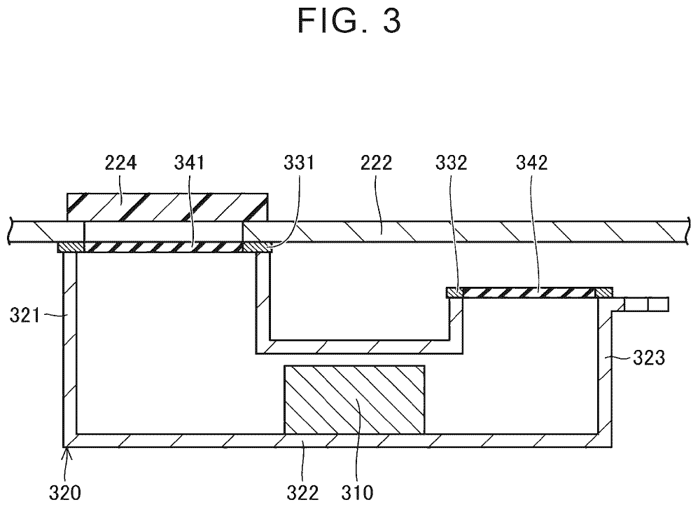

The discharge-side holding plate 331 is connected to an upper end of the discharge-side vertical path 321. The discharge-side filter 341 is held by the discharge-side holding plate 331. As shown in FIG. 3, the discharge-side holding plate 331 holds the discharge-side filter 341 such that the discharge-side filter 341 is disposed between the discharge portion 224 and the discharge-side vertical path 321.

The suction-side holding plate 332 is connected to an upper end of the suction-side vertical path 323. The suction-side filter 342 is held by the suction-side holding plate 332. The suction-side holding plate 332 holds the suction-side filter 342 such that the suction-side filter 342 is disposed at a position away from the top wall 222.

As described above, in the energy storage device 1 according to the present embodiment, the desulfurization agent 310 is supported by the support path 322 extending horizontally. Therefore, even when the desulfurization agent 310 is crushed due to vibration or the like, the air permeability between the case 200 and the discharge portion 224 is ensured through the space in the upper portion of the support path 322. Therefore, the discharge portion 224 is suppressed from being blocked.

The communication path 320 is connected to the top wall 222, and is disposed in an upper space of the case 200 where the concentration of the hydrogen sulfide gas is relatively low. Therefore, even if the hydrogen sulfide gas is generated in the case 200, it is suppressed that a high concentration of the hydrogen sulfide gas enters the desulfurization unit 300 and that desulfurization in the desulfurization unit 300 becomes insufficient.

It will be understood by those skilled in the art that the exemplary embodiments described above are illustrative of the aspects described below.

### First Aspect

An energy storage device includes:
a plurality of energy storage cells;
a case that houses the energy storage cells; and
a desulfurization unit disposed in the case.

The case includes a top wall disposed above the energy storage cells.

The top wall includes a discharge portion that discharges gas from inside the case to outside the case.

The desulfurization unit includes
a desulfurization agent, and
a communication path that contains the desulfurization agent and that allows inside of the case to communicate with the discharge portion, and
the communication path includes
a discharge-side vertical path extending downward from the discharge portion,
a support path extending horizontally from a lower end of the discharge-side vertical path and supporting the desulfurization agent, and
a suction-side vertical path extending upward from an end of the support path and opening into the case.

In this energy storage device, since the desulfurization agent is supported in the support path extending horizontally, even when the desulfurization agent is crushed due to vibration or the like, the air permeability between the case and the discharge portion is ensured through the space in the upper portion of the support path. Therefore, blockage of the discharge portion is suppressed.

In addition, the communication path is connected to the top wall, and is disposed in an upper space of the case where the concentration of the hydrogen sulfide gas is relatively low. Therefore, even if the hydrogen sulfide gas is generated in the case, it is suppressed that a high concentration of the hydrogen sulfide gas enters the desulfurization unit and desulfurization in the desulfurization unit becomes insufficient.

### Second Aspect

In the energy storage device according to the first aspect the discharge portion is a pressure regulating valve that regulates a pressure in the case.

### Third Aspect

In the energy storage device according to the second aspect, the desulfurization unit includes
a discharge-side holding plate connected to an upper end of the discharge-side vertical path,
a suction-side holding plate connected to an upper end of the suction-side vertical path,
a discharge-side filter held by the discharge-side holding plate, and
a suction-side filter held by the suction-side holding plate, and
the discharge-side holding plate holds the discharge-side filter in such a manner that the discharge-side filter is disposed between the pressure regulating valve and the discharge-side vertical path.

### Fourth Aspect

In the energy storage device according to any one of the first to third aspects, the support path includes
a first path extending in a first direction perpendicular to a vertical direction from the lower end of the discharge-side vertical path,
a second path extending in the first direction from a lower end of the suction-side vertical path, and
a third path connecting the first path and the second path, and
the third path is in a shape extending in a second direction perpendicular to both the vertical direction and the first direction.

It should be understood that the embodiments disclosed herein are illustrative and non-restrictive in all respects. The scope of the present disclosure is defined by the terms of the claims, rather than the description of the embodiments described above, and includes all modifications within the scope and meaning equivalent to the terms of the claims.

What is claimed is:

1. An energy storage device comprising:
a plurality of energy storage cells;
a case that houses the energy storage cells; and
a desulfurization unit disposed in the case, wherein:
the case includes a top wall disposed above the energy storage cells;
the top wall includes a discharge portion that discharges gas from inside the case to outside the case;
the desulfurization unit includes
a desulfurization agent, and
a communication path that contains the desulfurization agent and that allows inside of the case to communicate with the discharge portion; and
the communication path includes
a discharge-side vertical path extending downward from the discharge portion,
a support path extending horizontally from a lower end of the discharge-side vertical path and supporting the desulfurization agent, and
a suction-side vertical path extending upward from an end of the support path and opening into the case.

2. The energy storage device according to claim 1, wherein the discharge portion is a pressure regulating valve that regulates a pressure in the case.

3. The energy storage device according to claim 2, wherein:
the desulfurization unit further includes
a discharge-side holding plate connected to an upper end of the discharge-side vertical path,
a suction-side holding plate connected to an upper end of the suction-side vertical path,
a discharge-side filter held by the discharge-side holding plate, and
a suction-side filter held by the suction-side holding plate; and
the discharge-side holding plate holds the discharge-side filter in such a manner that the discharge-side filter is disposed between the pressure regulating valve and the discharge-side vertical path.

4. The energy storage device according to claim 1, wherein:
the support path includes
a first path extending in a first direction perpendicular to a vertical direction from the lower end of the discharge-side vertical path,
a second path extending in the first direction from a lower end of the suction-side vertical path, and
a third path connecting the first path and the second path; and
the third path is in a shape extending in a second direction perpendicular to both the vertical direction and the first direction.
